(19) United States
(12) Patent Application Publication
(10) Pub. No.: US 2024/0271812 A1
(43) Pub. Date: Aug. 15, 2024

(54) DETECTION OF ANOMALIES IN HEAT PUMP OPERATION BASED ON ENERGY SIMULATION

(71) Applicant: Performance Systems Development of New York, LLC, Ithaca, NY (US)

(72) Inventor: Gregory Thomas, Ithaca, NY (US)

(21) Appl. No.: 18/688,229

(22) PCT Filed: Jul. 5, 2023
(86) PCT No.: PCT/US2023/026956

§ 371 Date: Feb. 29, 2024

Related U.S. Application Data
(60) Provisional application No. 63/358,711, filed on Jul. 6, 2022.

(51) Int. Cl. F24F 11/38; F24F 11/52; F24F 140/60

(52) U.S. Cl. CPC F24F 11/38; F24F 11/52; F24F 2140/60

(57) ABSTRACT

Systems, devices, and methods including collecting data on a building and one or more heat pumps in the building; generating, by a server, a simulated energy data for the building and the one or more heat pumps; processing, by the server, the generated simulated energy data with a first bin analysis; collecting, by the server, an energy usage data for the building and heat pump; processing, by the server, the collected energy usage data with a second bin analysis; comparing, by the server, a change in usage for each bin in the first bin analysis and the second bin analysis; determining, by the server, if there is a significant difference in the compared change in usage for each across each progressive bin; determining, by the server, if a failure of one or more performance failure types has occurred to the one or more heat pumps.

### CROSS REFERENCE TO RELATED APPLICATION

This application is a 35 U.S.C. § 371 National Stage Entry of International Application No. PCT/US2023/026956 filed Jul. 5, 2023, which claims priority to and the benefit of U.S. Provisional Patent Application Ser. No. 63/358,711 filed Jul. 6, 2022, all of which are incorporated herein by reference in their entirety for all purposes.

### FIELD OF ENDEAVOR

The invention relates to heating and cooling, and more particularly to heating and cooling of buildings.

### BACKGROUND

Heat pumps are most often installed with backup heating sources. As a properly configured system, a heat pump and backup source operate together to provide a cost-effective, comfortable indoor temperature despite hot and cold climatic fluctuations. On occasion, these backup heating sources obscure the failure and/or inefficient operation of the heat pumps, delaying the ability of a homeowner to determine that the heat pumps are not functioning appropriately. Delayed detection and correction of degraded heat pump causes higher energy bills and distrust of heat pump technology. Utilities paying incentives for heat pump installations want those installations to reliably operate efficiently and with high customer satisfaction. Unfortunately, because the backup source is expected to supplement the heat pump during nominal operation, prompt detection and correction of a poorly performing heat pump can be difficult. In some cases, the problem may only be recognized when temperature falls well-below freezing because both the heat pump and the backup collectively fail to provide adequate heating.

### SUMMARY

A method embodiment may include: collecting data on a building and a heat pump in the building; generating, by a server, a simulated energy data for the building as a whole and for the operation of individual heat pumps proposed or installed in the building and used to supply the heating and cooling services for the building; processing, by the server, the generated simulated energy data with a first bin analysis; collecting, by the server in communication with a utility meter for the building, an energy usage data for the building and heat pump; processing, by the server, the collected energy usage data with a second bin analysis; comparing, by the server, a change in usage for each bin in the first bin analysis and the second bin analysis; determining, by the server, if there may be a significant difference in the compared change in usage for the same bin in the second bin analysis; determining, by the server, if a failure of one or more performance types has occurred to the heat pump if there may be a determined difference in the compared change in usage for each bin and one or more patterns of these differences, where the one or more patterns may be compared to known patterns of changes for failures; and sending, by the server, an alarm to a real-time feedback reporting module if the failure may be determined, where the alarm comprises an information about the failure of the one or more performance failure types.

In additional method embodiments, the collected data on the building comprises one or more of: a detail of a heat transfer properties of one or more building envelope components; a type and a performance characteristics of energy consuming equipment in the building including one or more of: a heating, a cooling, a hot water, and a ventilation equipment; a make, a model and, a performance characteristics of any proposed or installed heat pumps; and an operation of the building by occupants.

In additional method embodiments, the simulated energy data for the building as a whole comprises one or more of: heating, cooling, hot water, lighting, and appliances. In additional method embodiments, the simulated energy data for the building as a whole comprises one or more of: the heat pump and the building.

In additional method embodiments, the collected energy usage data for the building and the heat pump comprises usage data for the building as a whole. In additional method embodiments, the collected energy usage data for the building as a whole comprises a collective energy usage, and each heat pump does not need to be metered.

In additional method embodiments, criteria to determine if the difference between each bin may be significant varies based on the collected data on the building. In additional method embodiments, a building with a plurality of heat pumps has a smaller threshold than a building with one heat pump.

A method embodiment may include: collecting data on a building and one or more heat pumps in the building; generating, by a server, a simulated energy data for the building as a whole and for the operation of one or more heat pumps proposed or installed in the building and used to supply at least one of: a heating service and a cooling service for the building; processing, by the server, the generated simulated energy data with a first bin analysis; collecting, by the server in communication with a utility meter for the building, an energy usage data for the building and the one or more heat pumps; processing, by the server, the collected energy usage data with a second bin analysis; comparing, by the server, a change in usage for each bin in the first bin analysis and the second bin analysis; determining, by the server, if there may be a significant difference, detected by analyzing if the change in the slope of usage per degree of delta T across adjacent bins for a bin analysis of actual usage exceeds a threshold, and the difference between the predicted energy use at the bin and the metered or sub metered energy use at the same temperature bin exceeds a different threshold, where the thresholds used vary based on at least one of: a climate and a number of heat pumps installed on an electrical circuit read by a meter or a submeter; determining, by the server, if a failure of one or more performance types has occurred to the one or more heat pumps if there may be a determined difference in the compared change in usage for each bin and one or more patterns of these differences, where the one or more patterns may be compared to one or more known patterns of changes for failures; and sending, by the server, an alarm to a real-time feedback reporting module if the failure may be determined, where the alarm comprises an information about the failure of the one or more performance failure types.

In additional method embodiments, the collected data on the building comprises one or more of: a detail of a heat transfer properties of one or more building envelope components; a type and a performance characteristics of energy consuming equipment in the building including one or more of: a heating, a cooling, a hot water, and a ventilation equipment; a make, a model and, a performance characteristics of any proposed or installed heat pumps; and an operation of the building by occupants.

In additional method embodiments, the simulated energy data for the building as a whole comprises one or more of: heating, cooling, hot water, lighting, and appliances. In additional method embodiments, the simulated energy data for the building as a whole comprises one or more of: the one or more heat pumps and the building. In additional method embodiments, the collected energy usage data for the building and the heat pump comprises usage data for the building as a whole. In additional method embodiments, the collected energy usage data for the building as the whole comprises a collective energy usage, and where each heat pump does not need to be individually submetered.

In additional method embodiments, a criteria to determine if the difference between each bin may be significant varies based on the collected data on the building. In additional method embodiments, a building with a plurality of heat pumps has a smaller threshold than a building with one heat pump.

Another method embodiment may include: regulating temperature in a building with a system including one or more heat pumps and at least one backup heating system to backup the heat pump; providing an energy usage prediction for the building that accounts for seasonal temperature fluctuation; providing an energy usage observation for the building as a function of an energy consumption measurement; and performing a comparison of the energy usage prediction and the energy usage observation to assess performance of at least one of: the one or more heat pumps and the at least one backup heating system.

In additional method embodiments, the system includes a plurality of heat pumps. In additional method embodiments, the energy usage prediction may be representative of one or more of: heating, cooling, hot water, lighting, and appliances. In additional method embodiments, the system includes a plurality of heat pumps.

Additional method embodiments may include: applying a utility meter to provide the energy consumption measurement. Additional method embodiments may include: applying submeter data for measuring heating and cooling energy.

A system embodiment may include: a server comprising a processor having addressable memory, where the server may be configured to: collect data on a building and one or more heat pumps in the building; generate a simulated energy data for the building as a whole and for the operation of one or more heat pumps proposed or installed in the building and used to supply at least one of: a heating service and a cooling service for the building; process the generated simulated energy data with a first bin analysis; collect an energy usage data for the building and the one or more heat pumps; process the collected energy usage data with a second bin analysis; compare a change in usage for each bin in the first bin analysis and the second bin analysis; determine if there may be a significant difference in the compared change in usage for a same bin in the second bin analysis; determine if a failure of one or more performance types has occurred to the one or more heat pumps if there may be a determined difference in the compared change in usage for each bin and one or more patterns of these differences, where the one or more patterns may be compared to one or more known patterns of changes for failures; and send an alarm to a real-time feedback reporting module if the failure may be determined, where the alarm comprises an information about the failure of the one or more performance failure types.

In additional system embodiments, the building may be equipped with a plurality of heat pumps. In additional system embodiments, the energy usage prediction may be a simulation generated by the system. In additional system embodiments, the energy usage prediction for the building may be representative of one or more of: heating, cooling, hot water, lighting, and appliances. In additional system embodiments, the system utilizes submeter data for heating energy. In additional system embodiments, the collected energy usage data for the building and the one or more heat pumps may be from a utility meter for the building.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIGS. 1A-1F depict charts of predicted energy use compared to various failure modes, according to one embodiment;

FIG. 2 depicts a chart of predicted energy use as compared to actual energy use showing a fault detected by the system, according to one embodiment;

FIG. 3A depicts a chart of energy data with and without 50% random noise, according to one embodiment;

FIG. 3B depicts average energy for each temperature bin, according to one embodiment;

FIG. 4 depicts a chart of electricity usage at varying outside temperatures, according to one embodiment;

FIG. 5A depicts a chart of normalized metered and modeled energy use of a heat pump, according to one embodiment;

FIG. 5B depicts a chart of change in bin-to-bin normalized heat pump energy use based on the normalized hear pump energy use of FIG. 5A, according to one embodiment;

FIG. 6 is a flowchart of a method embodiment for a temperature bin-based fault detection based on deltas between bins and between predicted energy use and measured energy use for a heat pump, according to one embodiment;

FIGS. 7A-7B depict a system for real time monitoring of an actual gas furnace backup overuse and a simulated electric backup overuse, according to one embodiment;

FIGS. 8A-8B depict predicted hourly energy use and resulting predicted energy use per temperature bin for a less efficient heat pump model, according to one embodiment;

FIGS. 9A-9B depict predicted hourly energy use and resulting predicted energy use per temperature bin for a more efficient heat pump model, according to one embodiment;

FIG. 10 depicts a high-level block diagram of a system for detecting anomalies in heat pump operation, according to one embodiment;

FIG. 11 is a flowchart of a method embodiment for detecting anomalies in heat pump operation, according to one embodiment;

FIG. 12 shows a high-level block diagram and process of a computing system for implementing an embodiment of the system and process;

FIG. 13 shows a block diagram and process of an exemplary system in which an embodiment may be implemented; and

FIG. 14 depicts a cloud computing environment for implementing an embodiment of the system and process disclosed herein.

### DETAILED DESCRIPTION

The following description is made for the purpose of illustrating the general principles of the embodiments disclosed herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

Occupied buildings commonly include Heating, Venting, and Air Conditioning (HVAC) equipment to provide a comfortable, well-regulated indoor temperature. When properly selected, implemented, and maintained, HVAC equipment accounts for seasonal variation common to the area in terms of temperature, humidity, and the like. HVAC equipment commonly generates heat from combustion of fossil fuel with a furnace, conversion from electric power with a heater, or both. Heat pump technology promises to reduce energy consumption as compared to furnaces, heaters, and the like. As used herein, “heat pump technology” broadly encompasses the transfer of heat from one location to another by applying the refrigeration cycle in a manner resembling operation of an air conditioner or refrigerator. The source of heat may vary widely, including, for example, outdoor air, geothermal energy originating underground, waste heat from industrial activity, any combination of these, and/or other sources.

HVAC equipment including one or more heat pumps routinely includes another heat source to backup or supplement heat pump operation. Supplemental and/or backup equipment may mask heat pump underperformance. The failure and/or the inefficient operation of the heat pumps may cause problems for the heating of buildings. A manufacturer may supply a dedicated monitoring system for their equipment, or a contractor may install a special monitoring system to monitor the heat pump. The manufacturer's hardware approaches may be expensive to install and may not have automated fault detection, increasing the cost of monitoring performance to detect failure. Alternatively, linear regression analysis of energy usage data may be used to identify performance shortfalls over time. Linear regression analysis of usage data may contain more noise and requires more data across more weather periods to identify performance issues with heat pumps.

The disclosed system and method are low cost and manufacturer agnostic. The disclosed system and method identify failures in proper operation of a heat pump in a building. The binning of the energy data may reduce and/or eliminate the need to weather normalize energy data using linear regression and/or otherwise match the weather of the energy model to the actual weather experienced by the building.

The disclosed system and method processes building energy data and compares it to site-specific energy simulation outputs and detects when heat pump operation is not as expected. The disclosed system and method cost effectively produce an energy model that accurately reflects the load of the building and the operation of specific installed cold climate air source heat pump equipment. The simulation results may be processed with a bin method that may be used to identify the expected energy use at each two-degree temperature bin. These predictions may be compared to whole building interval data processed the same way.

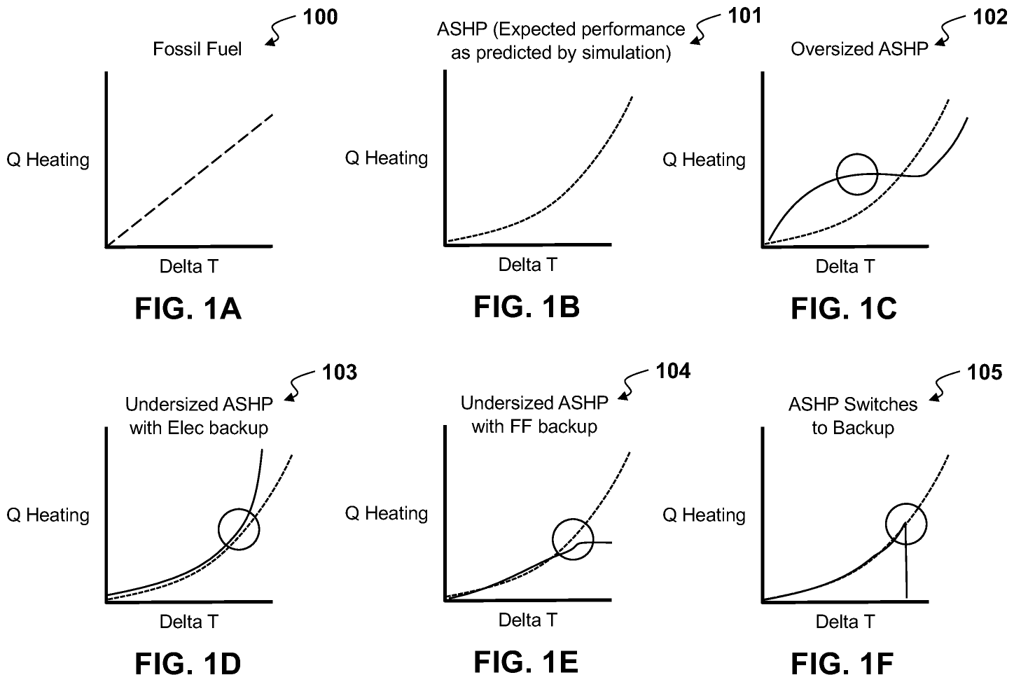

FIGS. 1A-1F depict charts 100, 101, 102, 103, 104, 105 of predicted energy use compared to various possible failure modes. As outside air temperatures change, the performance of the heat pump changes. Common failure modes, including incorrect control configuration or occupant misuse, can be detected by differences in the performance between predicted and actual energy use. Chart 100 shows a fossil fuel (FF) heater. Chart 100 is the expected chart for a functioning fossil fuel heater. Fossil fuel equipment efficiency is not significantly temperature dependent. So, the consumption of energy relative to outdoor temperature shows up as a linear relationship. In addition, the backup systems (non-heat pump electric or fossil fuel) alter the electric consumption significantly. Chart 101 shows an expected air-source heat pump (ASHP). The expected graph is shown in dashed lines. The expected graph shows expected performance as predicted by simulation. Chart 102 shows an oversized ASHP. The actual graph is shown in solid lines. The fault location is identified with a circle where the expected graph deviated from the actual graph. Chart 103 shows an undersized ASHP with an electric backup. Chart 104 shows an undersized ASHP with a fossil fuel (FF) backup. Chart 105 shows an ASHP that switches to a backup. Chart 105 depicts a scenario where the heat pump is shut off at temperatures below a set point. This can happen by mistake or at too high an outdoor temp if the contractor sets up the system incorrectly. The cases with the heat pump running at the same time as back up are shown in Chart 103 and Chart 104.

The failure in chart 102 results from air source heat pump equipment operating at a capacity below the minimum variable output, resulting in equipment short cycling, a less efficient mode of operation. As the outdoor temperature becomes colder, the load on the equipment increases until the equipment resumes expected operation within its variable range. The failure in chart 103 results from an air source heat pump with electric backup being small compared to the design load. This results in the heat pump requiring back up non-heat pump electricity to meet comfort requirements, resulting in an increase over expected performance in the energy consumption of the building at colder outside temperatures. Chart 104 shows the same scenario with a fossil fuel backup instead of electricity. The heat pump continues to produce heat, perhaps with some reduction in output based on the model, and the non-electric fossil fuel backup supplies the additional heating energy required for comfort. Chart 104 is only electricity energy usage so the substitution of the heat pump electrical energy with non-electric fossil fuel energy results in the curve as shown. In chart 105, the controls, either by operator intervention or by contractor or manufacturer configuration setting results in a switch over to fossil fuel at an outdoor temperature threshold.

The X-axis in charts 100, 101, 102, 103, 104, 105 represents a Delta T or the temperature difference between the indoor air temperature where the building begins to require heat and the outside air temperature. The Y-axis in charts 100, 101, 102, 103, 104, 105 represents the space heating related electrical energy consumption of the building at a sample weather location.

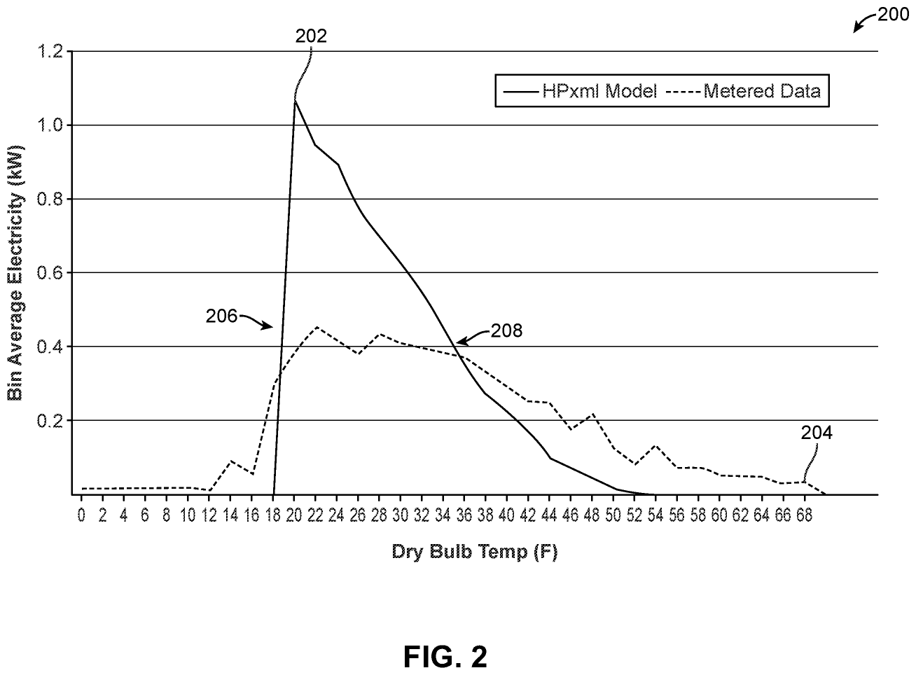

FIG. 2 depicts a chart 200 of predicted energy use as compared to actual energy use showing a fault detected by the system. The chart 200 depicts a dual fuel system showing heat pump compressor energy as compared to temperature. The y-axis shows bin average electricity in kilowatts (KW). The x-axis shows dry bulb temperature in Fahrenheit (F). Metered data 204 is shown as compared to the processed output of an energy simulation model configured to represent this specific house and heat pump, as shown by 202. The processed output of the simulation model, HPxml Model, shows a predicted energy use for each temperature. HPxml is a data standard used to put data into the energy simulation model. Alternative ways to enter the data are possible and contemplated. The HPxml model is a name for a model using HPxml data.

At a first temperature 206, there is a predicted switch over to fossil fuel, which aligns with measured data from the site 204. In one embodiment, the first temperature 206 may be 18 degrees F. (dashed line). Other temperatures are possible and contemplated.

At a second temperature 208, there is an unexpected use of fossil fuel. The metered data 204 diverges from the HPxml model 202. In one embodiment, the second temperature 208 may be 36 degrees F. Other temperatures are possible and contemplated.

The chart 200 provides an example of a heat pump that is running at the same time as a fossil fuel furnace. It is intended to switch to the heat pump at the first temperature, but it is using fossil fuel energy starting at the second temperature. Chart 200 is an example of a fault that is detected using the disclosed system and method. Chart 200 depicts data from a house.

The chart 200 has an x-axis that is similar but reversed in direction from the charts in FIGS. 1A-1F. The chart 200 uses actual outdoor temperature for X while the FIGS. 1A-1F charts use Delta Temperature (indoor temperature-outdoor temperature).

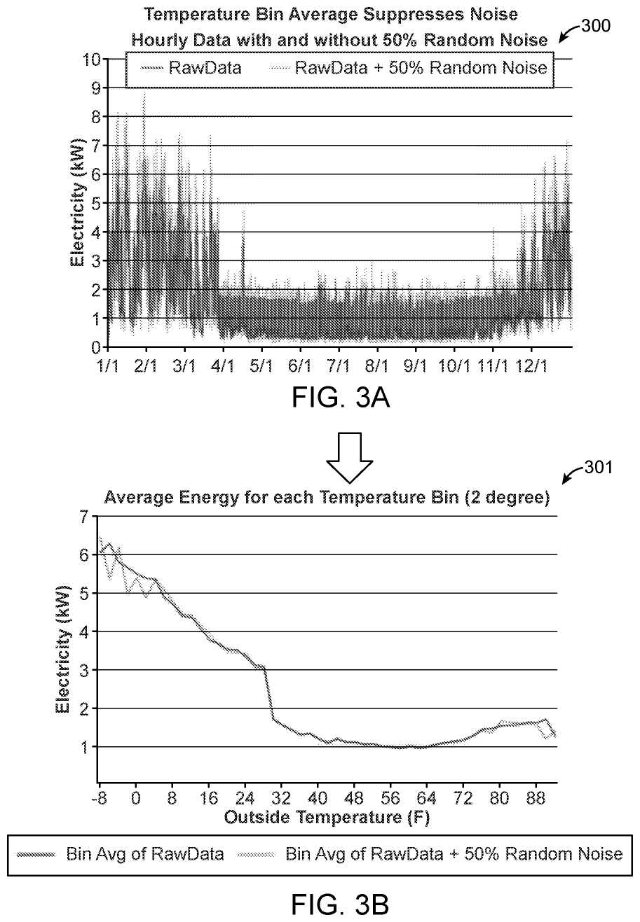

FIG. 3A depicts a chart 300 of one year of hourly energy data with and without 50% random noise. The chart 300 plots electricity usage in kilowatt (kW) for each hour over a year timeframe for a sample weather location. This chart used simulation data with added noise to demonstrates the impact of using temperature bin analysis to average the actual metered energy output from a house to an average value for each temperature bin. The X axis is the month and day, representing all 365 days in the simulation weather file.

FIG. 3B depicts a chart 301 of average energy for each temperature bin. The chart 301 shows average electricity usage in kilowatts (kW) as compared to the outside temperature in Fahrenheit (F). The disclosed bin method reduces noise in the signal and allows the detection after roughly one week or less of weather at the outdoor air temperature where the failure can be identified. Different faults will be detected at different temperatures. The fault will not be detected until the outdoor temperature passes through the range of the temperature dependent fault. A change in heat pump performance is very outdoor temperature dependent. When the outdoor temperature moves across a temperature where a fault occurs, there is a change in the usage that varies from the simulation based on a predicted change in usage. Most of the faults don't just happen at one temperature. Many faults initiate at a temperature or end at a temperature. Chart 301 shows the accuracy of the bin method in reducing the impact of the random noise over the course of the outside temperatures encountered over a year for a sample weather site.

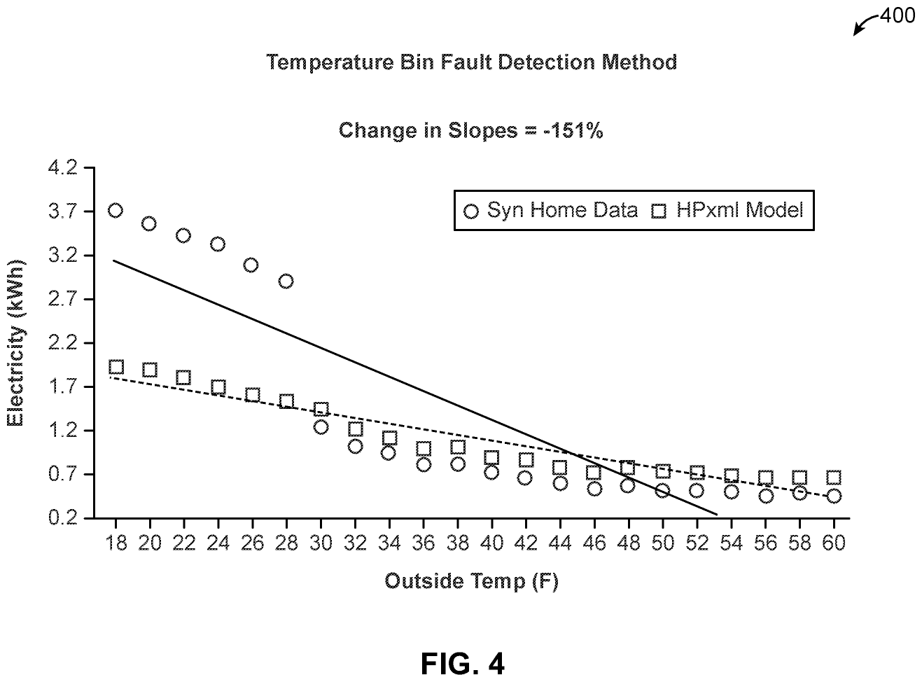

FIG. 4 depicts a chart 400 of electricity usage at varying outside temperatures. The chart 400 shows average electricity usage in kilowatt hours (kWh) as compared to outside temperature in Fahrenheit (F) grouped in bins of 2 degrees F. A 2-degree temperature bin is the number of hours when the outdoor temperature was within a range with an incremental value of 2 degrees. A 5-degree bin is the same for a 5 degree range increment. Hours accumulate faster with a 5-degree bin, but it is less precise about when the fault occurs. A 2-degree bin could be more affected by other site specific non heat pump factors. In some embodiments, a 2-degree bin and a 5 degree bin may both be used. Sample binned energy data represents a rapidly detectable shift in energy use due to a control failure in the air source heat pump such as described in Chart 103 (FIG. 1D). The blue dots and dashed line are the actual home data for electricity use while the orange dots and dashed line are the modeled electricity use, i.e., actual use is higher than expected by comparing the slopes of the dashed lines. A regression-based approach may not work as well as the disclosed system and method using the disclosed bins.

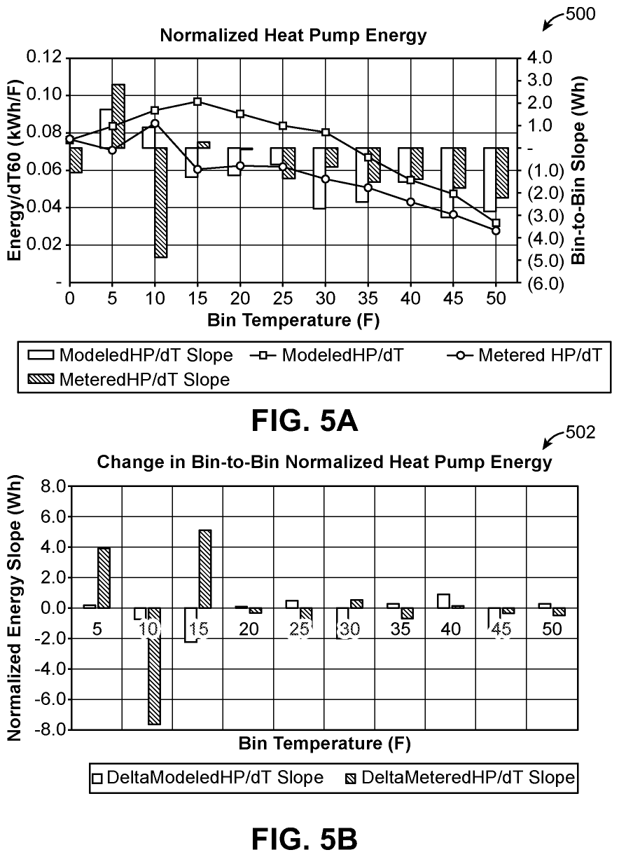

FIG. 5A depicts a chart 500 of normalized metered and modeled energy use of a heat pump. The chart 500 depicts a change in use from bin the bin, which is represented as a slope.

FIG. 5B depicts a chart 502 of change in bin-to-bin normalized heat pump energy use based on the normalized hear pump energy use of FIG. 5A. The chart 502 depicts change in the slope, which is a change in rate of change. The change in rate of change in use shows the fault in the actual usage more clearly as compared to the slope in chart 500 (FIG. 5A). In some embodiments, the disclosed system and method does not use the slopes for detection of faults. Detection of the faults happens in the disclosed system and method when the actual heating energy usage persistently diverges from the predicted heating energy usage across multiple bins. FIGS. 1-2 represent sample signatures that may be used to detect faults.

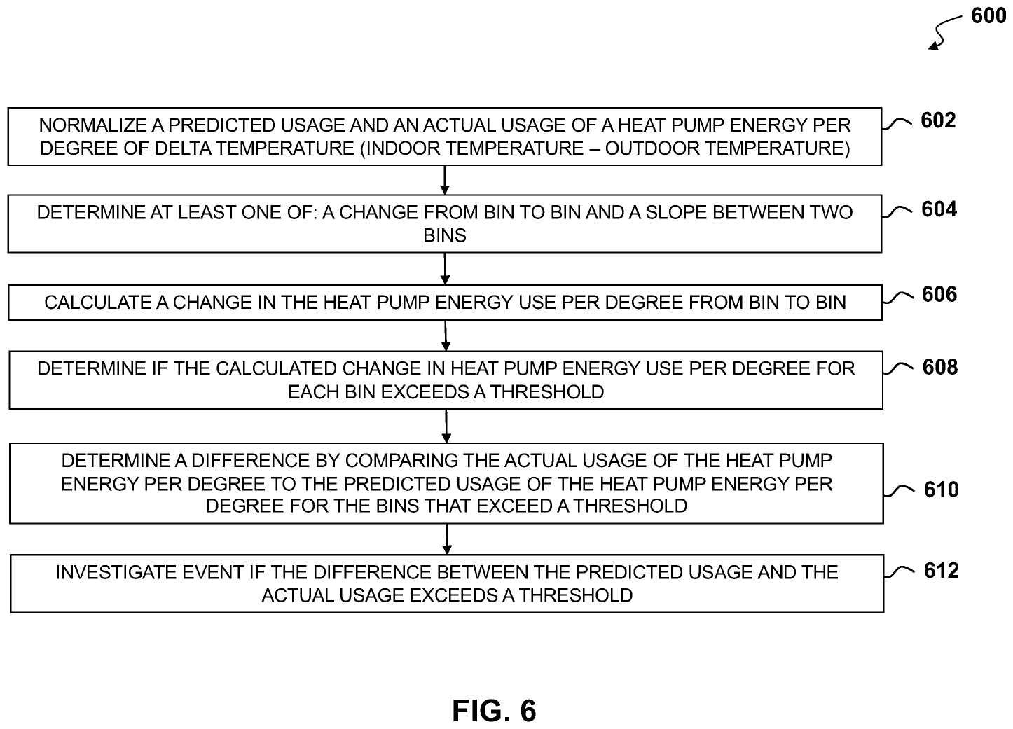

FIG. 6 is a flowchart of a method 600 embodiment for a temperature bin-based fault detection based on deltas between bins and between predicted energy use and measured energy use for a heat pump. FIG. 6 depicts a more effective temperature bin-based fault detection method 600. The average predicted and actual energy usage at each temperature bin is divided by the Delta T. A change in the heat pump energy use per degree between each temperature bin is calculated. Then the change in these the changes is calculated and compared to a situation appropriate threshold value. A second threshold test is applied to the identified bins, comparing the predicted normalized energy use to the actual normalized energy use for those identified bins.

The method 600 may include normalizing a predicted usage and an actual usage of a heat pump energy per degree of delta temperature (indoor temperature—outdoor temperature) (step 602). The method 600 may then include determining at least one of: a change from bin to bin and a slope between two bins (step 604). The result of these first two steps (602, 604) may be seen in the chart 500 (FIG. 5A). The method 600 may then include calculating a change in the heat pump energy use per degree from bin to bin (step 606). This third step 606 may be seen in the chart 502 (FIG. 5B). The method 600 may then include determining if the calculated change in heat pump energy use per degree for each bin exceeds a threshold (step 608). The method 600 may then include determining a difference by comparing the actual usage of the heat pump energy per degree to the predicted usage of the heat pump energy per degree for the bins that exceed a threshold (step 610). The method 600 may then include investigating the event if the difference between the predicted usage and the actual usage exceeds a threshold (step 612).

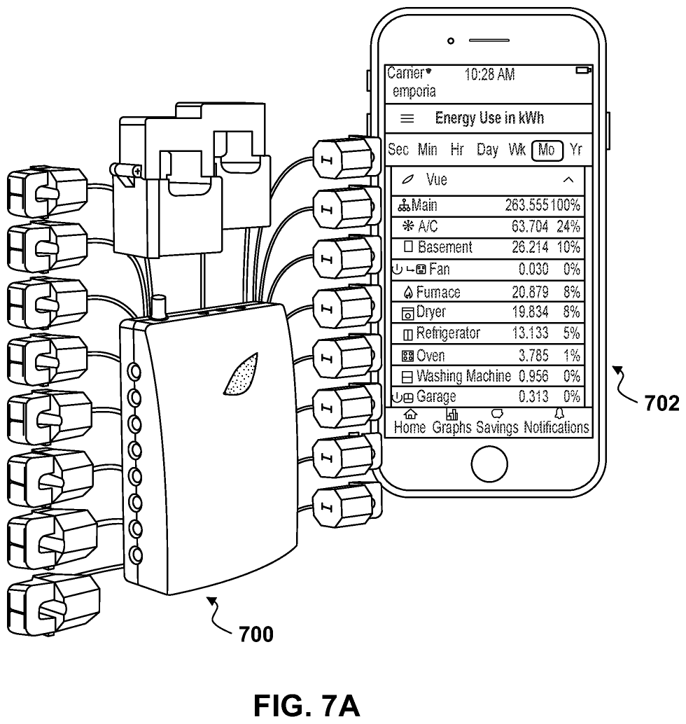

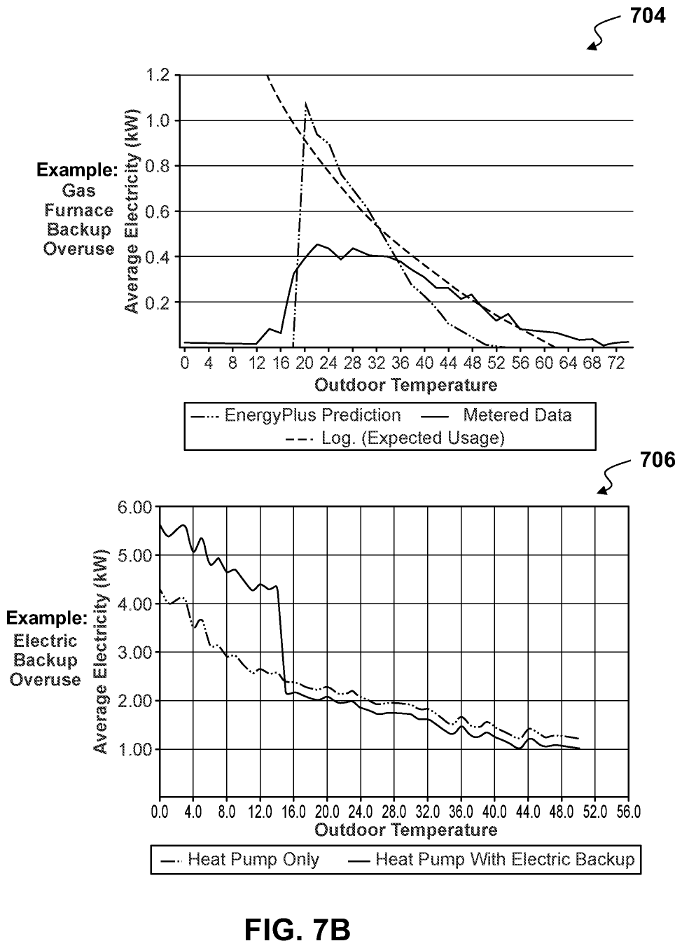

FIGS. 7A-7B depict a system for real time monitoring of an actual gas furnace backup overuse and a simulated electric backup overuse. FIG. 7A shows a sample sub metering device 700 that stores energy usage information collected in a secure cloud-based server for download by authorized users, such as by a user on a smartphone 702 or other computing device.

In FIG. 7B, a first chart 704 shows an example gas furnace backup overuse. The first chart 704 shows the prediction of the simulation compared to the energy use of the heat pump obtained from the sub meter device 700 (FIG. 7A). The actual electric energy consumption, as shown in a solid line, from the sub meter device 700 (FIG. 7A) shows that the natural gas furnace back up heat is running at the same time as the heat pump and reducing the energy used by the heat pump starting at roughly 38 degrees F. The predicted heat pump energy usage from the simulation, representing the intended operation of the heat pump, does not have the backup natural gas system running until it reaches the designed switch over temperature of 18 degrees F.

In FIG. 7B, the second chart 706 shows an example of electric back up heat turning on at 16 degrees F. This increases the measured electricity usage at that outdoor air temperature and colder.

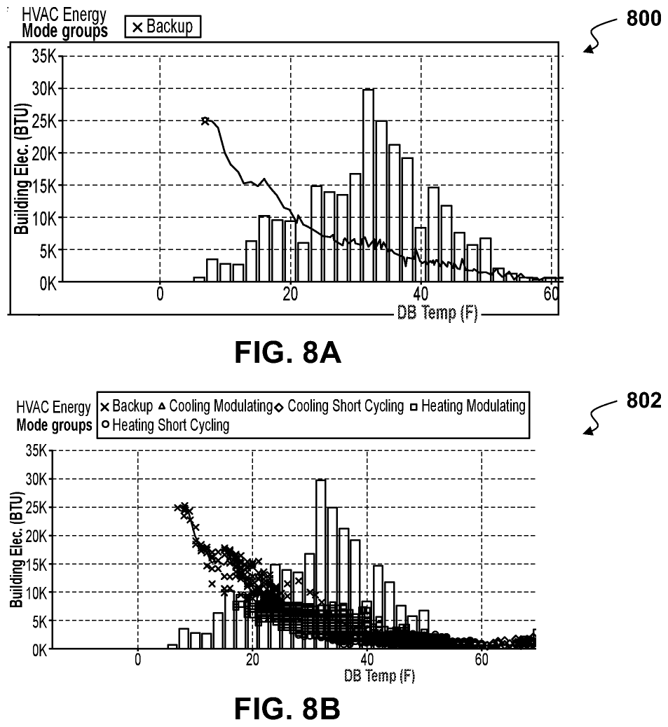

FIGS. 8A-8B depict predicted hourly energy use and resulting predicted energy use per temperature bin for a less efficient heat pump model. The sample bin-based usage from an energy simulation of a home with a heat pump is depicted in the first chart 800. The hourly energy usage data that generates the bin data is depicted in the second chart 802. The symbols in the second chart 802 represent operating conditions of the heat pump. Heating short cycling is the operation of the heat pump below the minimum turn down, representing the heat pump compressor turning on and off. Heating modulating is the operation of the heat pump in within its variable speed range. Backup represents expected use of back up energy to supplement the heat pump. FIGS. 8A-8B represent a specific heat pump with poor performance in a cold climate and therefore having higher predicted heating energy use in cold temperatures and overall.

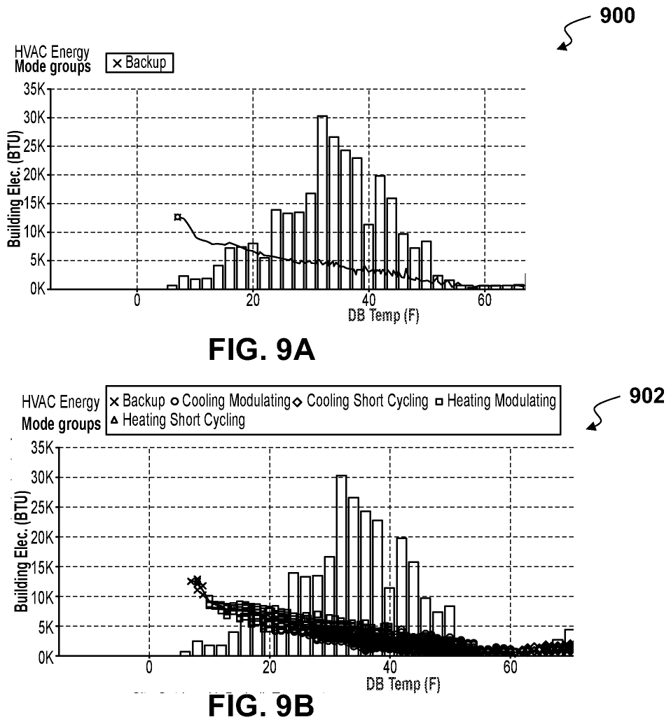

FIGS. 9A-9B depict predicted hourly energy use and resulting predicted energy use per temperature bin for a more efficient heat pump model. As compared to the heat pump for FIGS. 8A-8B, the heat pump in FIGS. 9A-9B represents a specific heat pump with good cold climate performance and therefore less total energy use and less use of back up energy. There are large differences in the total energy use and the usage at each temperature in the bin analysis. Modeling these variations in heat pump equipment performance correctly is required to create the correct predicted temperature binned energy use for the method. These equipment specific simulation calculations are necessary to use the disclosed system and method. The first chart 900 depicts resulting predicted energy use per temperature bin in a 1-degree bin example showing noise at that bin size. The second chart 902 shows predicted hourly energy use. The jaggedness of the line in these charts shows that one-degree bins results in more variation in the curve. By comparison, a 2-degree or 5-degree bin will result in a smoother curve.

FIGS. 8A-9B show that different heat pumps generate different energy by Delta T charts/curves. The cloud of points in FIG. 8B and FIG. 9B is the hourly data from the simulation. The line is the bin analysis of the hourly data and is used in the disclosed system and method to compare against actual usage (with a bin size of two-degrees or five-degrees). Other bin sizes are possible and contemplated.

The bar charts depicted in the background of FIGS. 8A-9B is the number of hours spent in each two-degree bin. These bar charts remain the same for each weather file location as it is defined by a typical year weather file used to run the simulation. The charts 800 (FIG. 8A), 802 (FIG. 8B), 900 (FIG. 9A), 902 (FIG. 9B) show an analysis of heat pump performance.

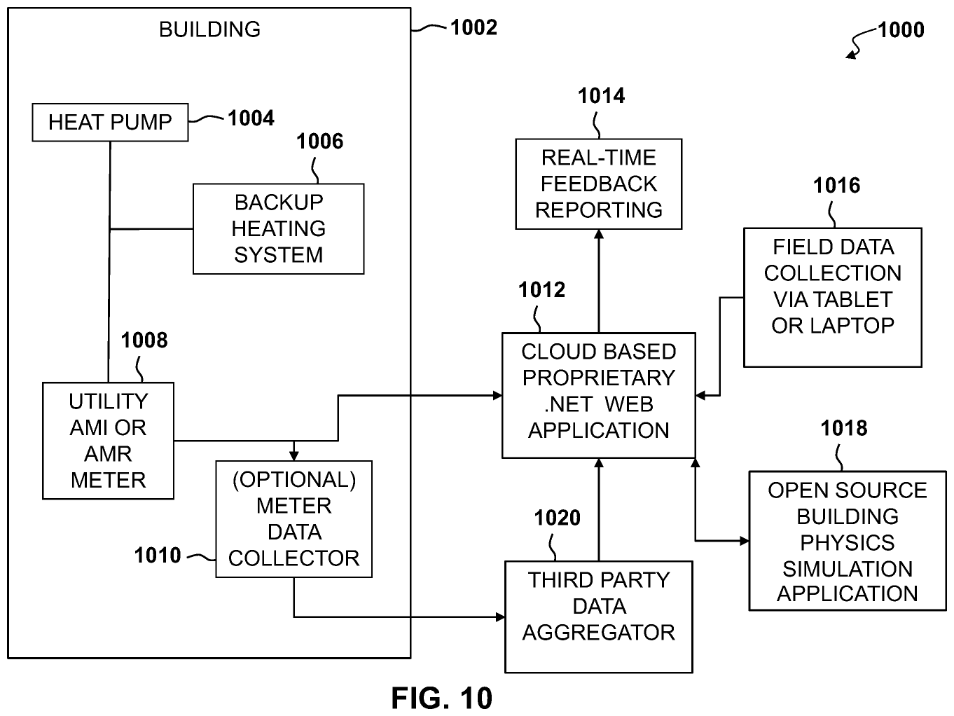

FIG. 10 depicts a high-level block diagram of a system 1000 for detecting anomalies in heat pump operation. The system 1000 may include a building 1002. The building 1002 may include a heat pump 1004, a backup heating system 1006, a utility AMI or AMR meter 1008, and an optional meter data collector 1010. A cloud based proprietary .NET web application 1012 may receive data from the utility meter data system 1008 on the functioning of the heat pump 1004 and/or backup heating system 1006. In some embodiments, the cloud based proprietary .NET web application 1012 may receive data from a third-party data aggregator 1020 that receives data from the optional meter data collector 1010. The cloud based proprietary .NET web application 1012 may also receive field data collection via a tablet or laptop 1016. This field data will describe the building walls, windows, attics, foundations and other building components, and the equipment in the building including proposed or existing heat pumps. This collected data is transformed into a data file and sent to the open source energy simulation middleware server 1018 application that transforms the data file into more or more HPXML data files which then generate one or more energy simulation files, which are then run by the open source building physics simulation application (also 1018). The results are passed back to the proprietary .NET web application 1012. The proprietary .NET web application may output data to a report via a real time reporting system such as a push notification or an emailed report or web interface or reporting server 1014 that can be accessed or sent to a user of the system.

The proprietary .NET application server 1012 may not connect directly to the utility meter 1008. The cloud based proprietary .NET web application 1012 may get data from a utility meter data system 1010 and/or through a third party 1020.

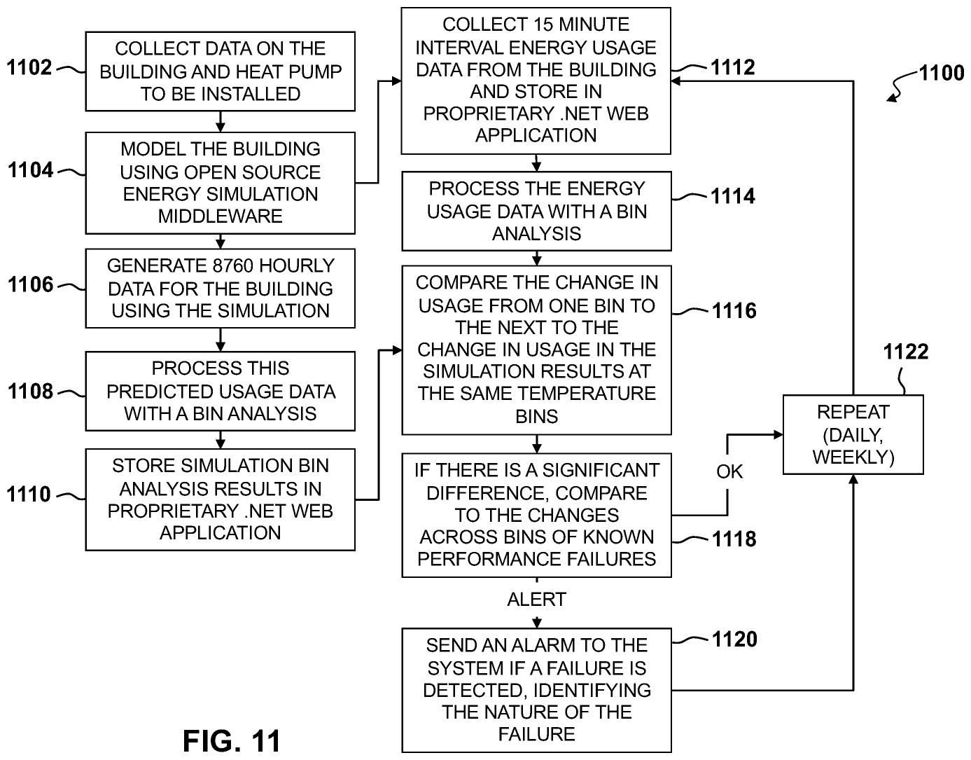

The building physics simulation Server 1018 may be a single server or bank of servers running a range of software tools designed to feed data to EnergyPlus (FIG. 11, step 1106) and send results back to the cloud based proprietary .NET web application 1012. Most significant of these is OpenStudio, an NREL open-source software framework for running EnergyPlus that specialized code (FIG. 11, steps 1104 and 1108) runs inside. This stack may be referred to as OpenStudio/EnergyPlus. Additional software packages and/or modules that are part of the installation of OpenStudio may include OpenStudio Server, an NREL open-source software and/or module for running multiple OpenStudio/EnergyPlus runs simultaneously. Software routines can be executed in OpenStudio to further transform the data in the HPXML file. The disclosed system 1000 may also include a communications software and/or module that looks for results and sends them back to the cloud based proprietary .NET web application 1012. OpenStudio is open-source middleware developed to reduce the cost of using the EnergyPlus building simulation software and other simulation tools. OpenStudio converts abstracted data objects into more detailed EnergyPlus inputs and calls EnergyPlus and reads results from EnergyPlus simulations. EnergyPlus is an open-source building physics simulation that is developed and maintained by the US Department of Energy.

In some embodiments, the bin analysis for predicted usage may be run in the cloud based proprietary .NET web application 1012. In some embodiments, running a building physics simulation server 1018 the disclosed system 1000 may run a fault detection bin analysis in the cloud based proprietary .NET web application 1012. In other embodiments, the fault detection bin analysis of the predicted energy use may be run on the building physics simulation server 1018. Heat pump operation can be degraded by a fault or defect in the equipment, inadequate repair or maintenance, improper operation, control, application, and the like. A heat pump installation requires the controls to be configured. Incorrect configuring of a control can increase energy use. For example the heat pump can be configured to turn off in cold temperatures, even if it is capable of operating efficiently at those temperatures. This is not uncommon.

The disclosed system 1000 is able to model the correct operation of most heat pumps 1004 according to manufacturer published performance specifications, such as those published in the Northeast Energy Efficiency Partners (NEEP) Cold Climate Air Source Database, and more quickly determine that the energy usage performance of the building 1002 is outside of what is expected for a specific temperature range. The nature of the change in performance will indicate the nature of the possible failure. The energy model used by the system 1000 may be a variation of the energy model used to calculate the correct size of the heat pump 1004 and to claim energy savings. In some embodiments, no special metering equipment is needed if interval (typically a utility meter reading every 15 minutes) meter data is available from the utility meter 1008 or the customer.

A low-cost whole building energy usage sensor 1010 may be deployed if the utility meter is not capable of producing interval meter data or if more granular data is desired. This sensor may be located at the electric panel or may pick up radio or WiFi signals from a placement in an electrical output located near the utility energy meter. The disclosed system 1000 separately reduces the cost of generating a detailed energy simulation for each building.

The disclosed system applies a proprietary approach to processing the simulation data via a bin analysis, which avoids the need to run a full simulation. The bin analysis normalizes both the predicted and actual energy usage to a common value for comparison. Real time weather suitable for use in an hourly simulation is available only after a delay, and a delay in detection increases the exposure of the home with a heat pump to unintended high bills. This method supports near real time detection with weekly analysis to detect events and more frequent analysis once events are detected. Creating a fully calibrated simulation for event detection requires considerably more data collection and simulation model adjustment and therefore significantly increases the cost per building monitored compared to the proprietary bin method. The disclosed bin analysis may be used to process both the simulation outputs and the actual interval meter data from the utility meter 1008 and/or the meter data collector 1010. The size of the bin may vary with the climate and application. Two-degree bins have been tested to provide a combination of a reasonable amount of masking of noise while allowing for fast identification of faults. A 5-degree bin method can be applied before a 2-degree bin method if needed to reduce false positives. The subsequent application of the 2-degree bin will be used to determine the fault type.

The disclosed system 1000 may be tested by modeling heat pump 1004 installation failures in the simulation, reducing the need to collect large amounts of field data from the utility meter 1008 and/or the meter data collector 1010 to validate failure data patterns.

As the building 1002 experiences temperatures in a specific temperature range, the disclosed system 1000 accumulates electrical energy usage bin data that verifies performance (remotely commissions) of the heat pump 1004 for that temperature band or detects an unexpected change in performance and issues an alert. Gas data may be collected and tracked if available allowing a more accurate measurement of backup energy usage for gas backup heating systems. This detection can be done for any number of combinations of cold climate air source equipment across a large number of manufacturers (as in the NEEP Cold Climate Heat Pump Database, which currently has 80,000 different equipment configurations). Additional equipment configurations may be added from a database including manufacturer equipment performance data. The installed equipment cost is either 0 (access to utility interval meter 1008 data) or low (using a commercially available third-party meter 1010).

Heat pump performance and control failures are hard to detect, due to the backup system 1006 covering up the failure. More rapid detection of a problem is a high value to customers, contractors, and utilities. The disclosed system 1000 is less expensive than installing dedicated sensors to detect heat pump 1004 issues. The disclosed system 1000 works across manufacturers, which is important for a utility that might use a remote commissioning method across different heat pump manufacturers as selected by heat pump contractors.

The disclosed system 1000 may detect the effect of coordinated or

uncoordinated backup systems 1006 in reducing the operation time of the heat pump. The disclosed system 1000 is configured to rapidly determine that the heat pump 1004 is running too much or too little.

FIG. 11 is a flowchart of a method 1100 embodiment for detecting anomalies in heat pump operation. The method 1100 may include collecting data on the building and the heat pump to be installed (step 1102). Step 1102 may be accomplished via field data collected via tablet or laptop (1016, FIG. 10). The disclosed method 1100 may use transparent nonproprietary methods to simplify the collection of this data. The disclosed method 1100 adds fault detection on top of those methods. The method 1100 may then include modeling the building using PSD's Modified HPXML to OpenStudio measure (step 1104). The HPXML to OpenStudio measure is an open-source software that runs inside OpenStudio. It transforms an HPXML data file into an EnergyPlus file. PSD has extended this open-source method to more accurate model heat pumps using detailed manufacturer performance data. Step 1104 may be accomplished by the cloud based proprietary .NET web application (1012, FIG. 10) and/or the building physics simulation server (1018, FIG. 10). The method 1100 may then include generating 8760 hourly data for the building using the simulation (step 1106). The simulation can also be run at shorter or longer timesteps than an hour and for periods shorter than a year. Other timeframes are possible and contemplated. Step 1106 may be accomplished by the building physics simulation server (1018, FIG. 10). The method 1100 may then include processing this predicted usage data with a bin analysis (step 1108). The bin analysis (step 1108) may include grouping the simulated energy data in 2 degree F. bins. Step 1108 may be accomplished by PSD software run within the OpenStudio application on the building physics simulation server (1018, FIG. 10). The method 1100 may then include storing the simulation bin analysis results in PSD cloud based proprietary .NET web application (step 1110). Step 1110 may be accomplished by the cloud based proprietary .NET web application (1012, FIG. 10).

The method 1100 may then include collecting 15-minute interval energy usage data from the building and from storing this energy usage data in PSD CompassPlus (step 1112). Fifteen minutes may be the standard data provided by utility meters (1008, FIG. 10). Other intervals are possible and may be done by third-party data collection but at a higher cost. Step 1112 may be accomplished by the heat pump (1004, FIG. 10) and backup heating system (1006, FIG. 10), then the utility meter (1008, FIG. 10), and cloud based proprietary .NET web application server (1012, FIG. 10). In another embodiment, step 1112 may be accomplished by the meter data collector (1010, FIG. 10), third party data aggregator (1020, FIG. 10), and cloud based proprietary .NET web application server (1012, FIG. 10). The method 1100 may then include processing the energy usage data with a bin analysis (step 1114). Step 1114 may include grouping the actual energy data in 2-degree F bins. Step 1114 may be accomplished by the cloud based proprietary .NET web application server (1012, FIG. 10). The method 1100 may then include comparing the change in binned actual energy usage to the change in usage in the simulation results at the same temperature bins (step 1116). The first comparison may be made after roughly a week of temperatures in the range where a fault might become visible to allow detection of a fault. Simulating a year just allows the disclosed system and method to start tracking at any actual temperature. The current method may be heating focused. In some embodiments, there may be a limited low-cost fault detection method for heating energy use when there are heat pumps used that can be deployed at scale. In some embodiments, the disclosed system and method may track in the summer to detect poor performance. Cooling results may have a clear fault signature if usage is far out of line with expected usage. Metered and simulated cooling energy use does not have any back up energy use producing a signal. This eliminates certain types of back up energy faults (as shown in FIG. 1D, FIG. 1E and FIG. 1F) from cooling analysis. Other types of faults could still be detected but with different fault event signatures from heating. Cooling data fault detection can be enhanced by filtering data to only evaluate cooling data at nighttime sleeping hours. Filtering to only night hours and/or sleeping hours can also be used to enhance heating fault detection if solar panels are included on the building energy meter. The disclosed system and method support this type of tracking. Step 1116 may be accomplished by the cloud based proprietary .NET web application server (1012, FIG. 10). The method 1100 may then include, if there is a significant difference, comparing to the changes across bins of known performance failures (step 1118). When a change is detected, bin data will be compared against a table of changes that represent change patterns for specific faults as in FIG. 1. Determining what constitutes a significant difference may be tuned by a change to the threshold to reduce false positives. Step 1118 may be accomplished by the cloud based proprietary .NET web application server (1012, FIG. 10). If there is no significant difference, the method 1100 may include repeating the process at an interval, such as daily or weekly (step 1122). Bins may also be applied based on the time of day to understand changes in heat pump performance that depend on solar gains or building schedule of operations. In some embodiments, the ideal interval for this comparison is weekly. Other intervals are possible and contemplated. In other embodiments, the ideal interval may vary with outdoor temperature. There may be a disadvantage to constant comparisons, e.g., error from noise if the comparison is made with each new 15-minute energy interval data point, which is reduced by the disclosed binning. Step 1122 may be accomplished by the cloud based proprietary .NET web application server (1012, FIG. 10). If there is a significant difference, the method 1100 may include sending an alarm to the system if a failure is detected identifying the nature of the failure (step 1120). (Known performance failures are disclosed by example in FIG. 1.) A significant difference may be detected by analyzing if the change in the slope of usage per degree of delta T across adjacent bins for a bin analysis of actual usage exceeds a threshold, and the difference between the predicted energy use at the bin and the metered or sub metered energy use at the same temperature bin exceeds a different threshold, wherein the thresholds used vary based on at least one of: a climate and a number of heat pumps installed on an electrical circuit read by a meter or a submeter. Use of a submeter may reduce the influence of other energy usage in the building on the determination of fault events. For example, an electric vehicle charger could produce a large usage of energy that could mask heat pump energy use. A submeter measures usage of a subset of the all the electricity using devices in the building including the heat pump and excluding loads that can interfere with measurement. Submeters can also separately measure multiple heat pumps in a building, allowing for faster detection of faults and lower thresholds for fault detection. The submeter approach does increase the cost of setting up the fault detection system for a building. Step 1120 may be accomplished by the cloud based proprietary .NET web application server (1012, FIG. 10) and real-time feedback reporting module (1014, FIG. 10).

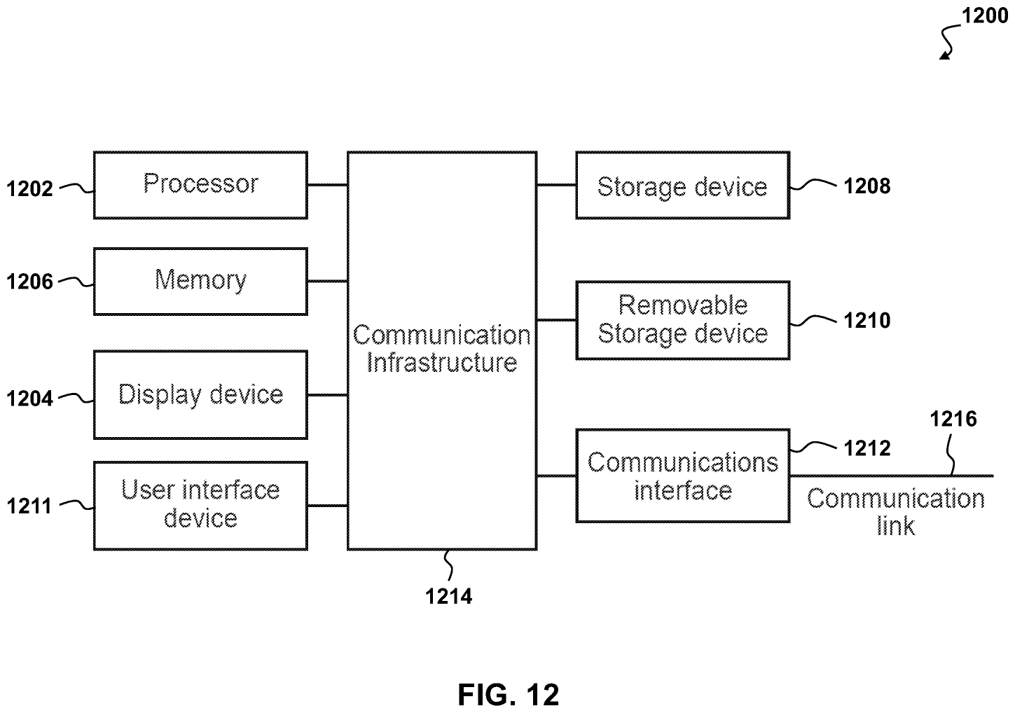

FIG. 12 is a high-level block diagram 1200 showing a computing system comprising a computer system useful for implementing an embodiment of the system and process, disclosed herein. Embodiments of the system may be implemented in different computing environments. The computer system includes one or more processors 1202, and can further include an electronic display device 1204 (e.g., for displaying graphics, text, and other data), a main memory 1206 (e.g., random access memory (RAM)), storage device 1208, a removable storage device 1210 (e.g., removable storage drive, a removable memory module, a magnetic tape drive, an optical disk drive, a computer readable medium having stored therein computer software and/or data), user interface device 1211 (e.g., keyboard, touch screen, keypad, pointing device), and a communication interface 1212 (e.g., modem, a network interface (such as an Ethernet card), a communications port, or a PCMCIA slot and card). The communication interface 1212 allows software and data to be transferred between the computer system and external devices. The system further includes a communications infrastructure 1214 (e.g., a communications bus, cross-over bar, or network) to which the aforementioned devices/modules are connected as shown.

Information transferred via communications interface 1212 may be in the form of signals such as electronic, electromagnetic, optical, or other signals capable of being received by communications interface 1212, via a communication link 1216 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1212. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

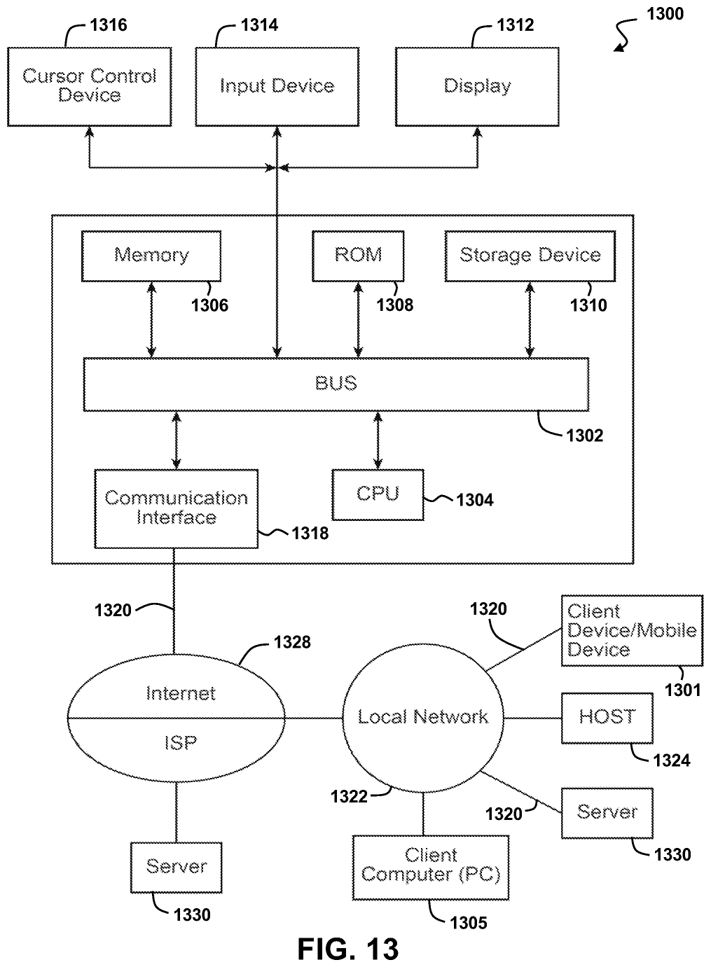

FIG. 13 shows a block diagram of an example system 1300 in which an embodiment may be implemented. The system 1300 includes one or more client devices 1301 such as consumer electronics devices, connected to one or more server computing systems 1330. A server 1330 includes a bus 1302 or other communication mechanism for communicating information, and a processor (CPU) 1304 coupled with the bus 1302 for processing information. The server 1330 also includes a main memory 1306, such as a random access memory (RAM) or other dynamic storage device, coupled to the bus 1302 for storing information and instructions to be executed by the processor 1304. The main memory 1306 also may be used for storing temporary variables or other intermediate information during execution or instructions to be executed by the processor 1304. The server computer system 1330 further includes a read only memory (ROM) 1308 or other static storage device coupled to the bus 1302 for storing static information and instructions for the processor 1304. A storage device 1310, such as a magnetic disk or optical disk, is provided and coupled to the bus 1302 for storing information and instructions. The bus 1302 may contain, for example, thirty-two address lines for addressing video memory or main memory 1306. The bus 1302 can also include, for example, a 32-bit data bus for transferring data between and among the components, such as the CPU 1304, the main memory 1306, video memory and the storage 1310. Alternatively, multiplex data/address lines may be used instead of separate data and address lines.

The server 1330 may be coupled via the bus 1302 to a display 1312 for displaying information to a computer user. An input device 1314, including alphanumeric and other keys, is coupled to the bus 1302 for communicating information and command selections to the processor 1304. Another type or user input device comprises cursor control 1316, such as a mouse, a trackball, or cursor direction keys for communicating direction information and command selections to the processor 1304 and for controlling cursor movement on the display 1312.

According to one embodiment, the functions are performed by the processor 1304 executing one or more sequences of one or more instructions contained in the main memory 1306. Such instructions may be read into the main memory 1306 from another computer-readable medium, such as the storage device 1310. Execution of the sequences of instructions contained in the main memory 1306 causes the processor 1304 to perform the process steps described herein. One or more processors in a multi-processing arrangement may also be employed to execute the sequences of instructions contained in the main memory 1306. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1304 for execution. Such a medium may take many forms, including but not limited to, non-volatile media, volatile media, and transmission media. Non-volatile media includes, for example, optical or magnetic disks, such as the storage device 1310. Volatile media includes dynamic memory, such as the main memory 1306. Transmission media includes coaxial cables, copper wire and fiber optics, including the wires that comprise the bus 1302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1304 for execution. For example, the instructions may initially be carried on a magnetic disk of a remote computer. The remote computer can load the instructions into its dynamic memory and send the instructions over a telephone line using a modem. A modem local to the server 1330 can receive the data on the telephone line and use an infrared transmitter to convert the data to an infrared signal. An infrared detector coupled to the bus 1302 can receive the data carried in the infrared signal and place the data on the bus 1302. The bus 1302 carries the data to the main memory 1306, from which the processor 1304 retrieves and executes the instructions. The instructions received from the main memory 1306 may optionally be stored on the storage device 1310 either before or after execution by the processor 1304.

The server 1330 also includes a communication interface 1318 coupled to the bus 1302. The communication interface 1318 provides a two-way data communication coupling to a network link 1320 that is connected to the world wide packet data communication network now commonly referred to as the Internet 1328. The Internet 1328 uses electrical, electromagnetic, or optical signals that carry digital data streams. The signals through the various networks and the signals on the network link 1320 and through the communication interface 1318, which carry the digital data to and from the server 1330, are exemplary forms or carrier waves transporting the information.

In another embodiment of the server 1330, interface 1318 is connected to a network 1322 via a communication link 1320. For example, the communication interface 1318 may be an integrated services digital network (ISDN) card or a modem to provide a data communication connection to a corresponding type of telephone line, which can comprise part of the network link 1320. As another example, the communication interface 1318 may be a local area network (LAN) card to provide a data communication connection to a compatible LAN. Wireless links may also be implemented. In any such implementation, the communication interface 1318 sends and receives electrical electromagnetic or optical signals that carry digital data streams representing various types of information.

The network link 1320 typically provides data communication through one or more networks to other data devices. For example, the network link 1320 may provide a connection through the local network 1322 to a host computer 1324 or to data equipment operated by an Internet Service Provider (ISP). The ISP in turn provides data communication services through the Internet 1328. The local network 1322 and the Internet 1328 both use electrical, electromagnetic, or optical signals that carry digital data streams. The signals through the various networks and the signals on the network link 1320 and through the communication interface 1318, which carry the digital data to and from the server 1330, are exemplary forms or carrier waves transporting the information.

The server 1330 can send/receive messages and data, including e-mail, program code, through the network, the network link 1320 and the communication interface 1318. Further, the communication interface 1318 can comprise a USB/Tuner and the network link 1320 may be an antenna or cable for connecting the server 1330 to a cable provider, satellite provider or other terrestrial transmission system for receiving messages, data, and program code from another source.

The example versions of the embodiments described herein may be implemented as logical operations in a distributed processing system such as the system 1300 including the servers 1330. The logical operations of the embodiments may be implemented as a sequence of steps executing in the server 1330, and as interconnected machine modules within the system 1300. The implementation is a matter of choice and can depend on performance of the system 1300 implementing the embodiments. As such, the logical operations constituting said example versions of the embodiments are referred to for e.g., as operations, steps, or modules.

Similar to a server 1330 described above, a client device 1301 can include a processor, memory, storage device, display, input device and communication interface (e.g., e-mail interface) for connecting the client device to the Internet 1328, the ISP, or LAN 1322, for communication with the servers 1330.

The system 1300 can further include computers (e.g., personal computers, computing nodes) 1305 operating in the same manner as client devices 1301, wherein a user can utilize one or more computers 1305 to manage data in the server 1330.

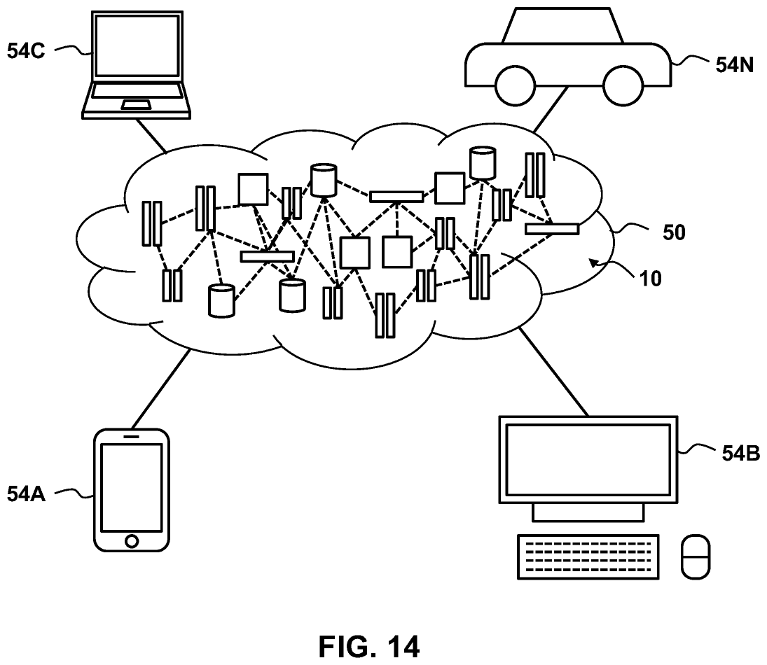

Referring now to FIG. 14, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. The nodes may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 14 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1. A method, comprising:
collecting data on a building and one or more heat pumps in the building;
generating, by a server, a simulated energy data for the building as a whole and for the operation of one or more heat pumps proposed or installed in the building and used to supply at least one of: a heating service and a cooling service for the building;
processing, by the server, the generated simulated energy data with a first bin analysis;
collecting, by the server in communication with a utility meter for the building, an energy usage data for the building and the one or more heat pumps;
processing, by the server, the collected energy usage data with a second bin analysis;
comparing, by the server, a change in usage for each bin in the first bin analysis and the second bin analysis;
determining, by the server, if there is a significant difference, detected by analyzing if the change in the slope of usage per degree of delta T across adjacent bins for a bin analysis of actual usage exceeds a threshold, and the difference between the predicted energy use at the bin and the metered or sub metered energy use at the same temperature bin exceeds a different threshold, wherein the thresholds used vary based on at least one of: a climate and a number of heat pumps installed on an electrical circuit read by a meter or a submeter;
determining, by the server, if a failure of one or more performance types has occurred to the one or more heat pumps if there is a determined difference in the compared change in usage for each bin and one or more patterns of these differences, wherein the one or more patterns are compared to one or more known patterns of changes for failures; and
sending, by the server, an alarm to a real-time feedback reporting module if the failure is determined, wherein the alarm comprises an information about the failure of the one or more performance failure types.

2. The method of claim 1, wherein the collected data on the building comprises one or more of: a detail of a heat transfer properties of one or more building envelope components; a type and a performance characteristics of energy consuming equipment in the building including one or more of: a heating, a cooling, a hot water, and a ventilation equipment; a make, a model and, a performance characteristics of any proposed or installed heat pumps; and an operation of the building by occupants.

3. The method of claim 1, wherein the simulated energy data for the building as a whole comprises one or more of: heating, cooling, hot water, lighting, and appliances.

4. The method of claim 1, wherein the simulated energy data for the building as a whole comprises one or more of: the one or more heat pumps and the building.

5. The method of claim 1, wherein the collected energy usage data for the building and the heat pump comprises usage data for the building as a whole.

6. The method of claim 5, wherein the collected energy usage data for the building as the whole comprises a collective energy usage, and wherein each heat pump does not need to be individually submetered.

7. The method of claim 1, wherein a criteria to determine if the difference between each bin is significant varies based on the collected data on the building.

8. The method of claim 7, wherein a building with a plurality of heat pumps has a smaller threshold than a building with one heat pump.

9. A method, comprising:
regulating temperature in a building with a system including one or more heat pumps and at least one backup heating system to backup the heat pump;
providing an energy usage prediction for the building that accounts for seasonal temperature fluctuation;
providing an energy usage observation for the building as a function of an energy consumption measurement; and
performing a comparison of the energy usage prediction and the energy usage observation to assess performance of at least one of: the one or more heat pumps and the at least one backup heating system.

10. The method of claim 9, wherein the system includes a plurality of heat pumps.

11. The method of claim 9, in which the energy usage prediction is representative of one or more of: heating, cooling, hot water, lighting, and appliances.

12. The method of claim 11, wherein the system includes a plurality of heat pumps.

13. The method of claim 9, further comprising:
applying a utility meter to provide the energy consumption measurement.

14. The method of claim 9, further comprising:
applying submeter data for measuring heating and cooling energy.

15. A system, comprising:
a server comprising a processor having addressable memory, wherein the server is configured to:
collect data on a building and one or more heat pumps in the building;
generate a simulated energy data for the building as a whole and for the operation of one or more heat pumps proposed or installed in the building and used to supply at least one of: a heating service and a cooling service for the building;
process the generated simulated energy data with a first bin analysis;
collect an energy usage data for the building and the one or more heat pumps;
process the collected energy usage data with a second bin analysis;
compare a change in usage for each bin in the first bin analysis and the second bin analysis;
determine if there is a significant difference in the compared change in usage for a same bin in the second bin analysis;
determine if a failure of one or more performance types has occurred to the one or more heat pumps if there is a determined difference in the compared change in usage for each bin and one or more patterns of these differences, wherein the one or more patterns are compared to one or more known patterns of changes for failures; and
send an alarm to a real-time feedback reporting module if the failure is determined, wherein the alarm comprises an information about the failure of the one or more performance failure types.

16. The system of claim 15, wherein the building is equipped with a plurality of heat pumps.

17. The system of claim 15, wherein the energy usage prediction is a simulation generated by the system.

18. The system of claim 15, wherein the energy usage prediction for the building is representative of one or more of: heating, cooling, hot water, lighting, and appliances.

19. The system of claim 15, wherein the system utilizes submeter data for heating energy.

20. The system of claim 15, wherein the collected energy usage data for the building and the one or more heat pumps is from a utility meter for the building.
